(19) United States
(12) Patent Application Publication
(10) Pub. No.: US 2012/0077000 A1
(43) Pub. Date: Mar. 29, 2012

(54) PROCESS FOR PRODUCING AN IMAGE FROM POROUS MARKING PARTICLES

(76) Inventors: David D. Putnam, Fairport, NY (US); Mridula Nair, Penfield, NY (US); Joseph S. Sedita, Albion, NY (US); Charles P. Lusignan, Rochester, NY (US); Po-Jen Shih, Webster, NY (US)

(21) Appl. No.: 12/889,716

(22) Filed: Sep. 24, 2010

(51) Int. Cl. G03G 13/20; B32B 5/16; B32B 3/10

(52) U.S. Cl. 428/207; 399/320

(57) ABSTRACT

A process of producing an image including transferring porous polymeric marking particles to a receiver, and fixing the marking particles to the receiver by applying heat and pressure by contacting the marking particles with a heated fuser member including a topcoat layer having a storage modulus of at least 10 MPa at 175° C. In particular embodiments, the invention is specifically directed towards fusing porous toner materials, and enables reducing the image relief, toner spread, and differential gloss of resulting fused toner images. Higher gloss and reduced differential gloss is obtained at similar or reduced toner spread, measured by toner particle area gain, allowing the use of reduced fusing conditions compared to solid toners.

### FIELD OF THE INVENTION

The invention relates generally to the field of imaging, and in particular to producing images from porous marking particles such as toner particles for electrostatographic printing. The invention in specific embodiments further relates to fusing toner images using a high storage modulus fluoropolymer fuser topcoat to form thinner stack height, glossy, photo-quality electrophotographic images with reduced differential gloss and toner relief.

### BACKGROUND OF THE INVENTION

In electrostatography an image comprising an electrostatic field pattern, usually of non-uniform strength, (also referred to as an electrostatic latent image) is formed on an insulative surface of an electrostatographic element by any of various methods. For example, the electrostatic latent image may be formed electrophotographically (i.e., by imagewise photo-induced dissipation of the strength of portions of an electrostatic field of uniform strength previously formed on a surface of an electrophotographic element comprising a photoconductive layer and an electrically conductive substrate), or it may be formed by dielectric recording (i.e., by direct electrical formation of an electrostatic field pattern on a surface of a dielectric material). Typically, the electrostatic latent image is then developed into a toner image by contacting the latent image with an electrostatographic developer.

One well-known type of electrostatographic developer comprises a dry mixture of toner particles and carrier particles. Developers of this type are commonly employed in well-known electrostatographic development processes such as cascade development and magnetic brush development. The particles in such developers are formulated such that the toner particles and carrier particles occupy different positions in the triboelectric continuum, so that when they contact each other during mixing to form the developer, they become triboelectrically charged, with the toner particles acquiring a charge of one polarity and the carrier particles acquiring a charge of the opposite polarity. These opposite charges attract each other such that the toner particles cling to the surfaces of the carrier particles. When the developer is brought into contact with the latent electrostatic image, the electrostatic forces of the latent image (sometimes in combination with an additional applied field) attract the toner particles, and the toner particles are pulled away from the carrier particles and become electrostatically attached imagewise to the latent image-bearing surface.

The toned image is next transferred to a receiver, which could be either a final receiver material such as paper, transparency, etc., or to an intermediate transfer member, such as a compliant intermediate and, from thence, to the final receiver member. Transfer can be accomplished by pressing the receiver against the primary imaging member, or in the case of transferring from a transfer intermediate to the final receiver, from the transfer intermediate member to the final receiver member and urging the toner particles from the member from whence the toner particles are being transferred to the member that is to receive the toner particles. This is generally accomplished by applying pressure. More commonly, pressure is applied in conjunction with either an applied electrostatic field or with heat that softens the toner particles.

The resultant toner image can then be fixed in place on the final receiver by application of heat and pressure or other known methods. Known to the electrostatographic fixing art are various fuser members adapted to apply heat and pressure to heat-softenable electrostatographic toner on a receiver, such as paper, to permanently fuse the toner to the receiver. Examples of fuser members include fuser rollers, pressure rollers, fuser plates, and fuser belts for use in fuser systems such as fuser roller systems, fuser plate systems, and fuser belt systems. The term “fuser member” is used herein to identify one of the elements of a fusing system. Fuser members have been proposed which comprise relatively compliant outer layers (i.e., having relatively low storage modulus of less than 10 MPa at 175° C.), as well as relatively non-compliant (i.e., having relatively high storage modulus of at least 10 MPa at 175° C.) outer layers provided over a compliant cushion base layer, such as described, e.g., in U.S. Pat. Nos. 7,494,706; 7,531,237; 7,534,492; and 7,682,542, and further in commonly assigned, copending U.S. patent application Ser. No. 12/647,573, “Fuser Member with Fluoropolymer Outer layer” of Chen, Pickering, and Shih. Commonly, the fuser member is a fuser roller or pressure roller and the discussion herein may refer to a fuser roller or pressure roller, however, the invention is not limited to any particular configuration of fuser member.

It is preferred to heat the toner particles with the fuser member to a temperature that exceeds the glass transition temperature of the toner particles so as to render them fluid. It is desirable that the toner particles have a sufficiently high glass transition temperature (Tg) to prevent the particles from sticking to each other in either the container that holds them until they are added to the carrier particles or to prevent the printed final receiver members from adhering to each other, thereby forming “bricks” of sheets. Alternatively, if the glass transition temperature of the toner particles is too high, the final receiver would have to be heated to an excessively high temperature that could degrade the fuser member and cause moisture or steam to be emitted from the final receiver member, especially when that receiver member comprises paper.

Many well-known types of toner useful in dry developers comprise binder polymer materials such as vinyl addition polymers or condensation polymers. Such binder polymers are chosen for their good combinations of advantageous properties, such as toughness, transparency, good adhesion to substrates, and fusing characteristics, such as the ability to be fixed to paper at relatively low fusing temperatures while not permanently adhering to fusing rolls, except at relatively high temperatures. As is well-known, vinyl addition polymers that are useful as binder polymers in toner particles can be linear, branched, or lightly crosslinked. The most widely used condensation polymers are polyesters which are polymers in which backbone recurring units are connected by ester linkages. Like the vinyl addition polymers, polyesters useful as binder materials in toner particles can be linear, branched, or lightly crosslinked. They can be fashioned from any of many different monomers, typically by polycondensation of monomers containing two or more carboxylic acid groups (or derivatives thereof, such as anhydride or ester groups) with monomers containing two or more hydroxy groups.

While many binder polymers exhibit many desirable properties for use in electrostatographic toners, they do have certain shortcomings. For example, binder polymers are commonly ground to a small particle size to provide the high degree of resolution required in color images. Unfortunately, many polymers, and especially polyesters which are otherwise useful for toners are not sufficiently easily ground to the very small particle sizes needed for high-resolution toners. To overcome this problem, methods have been developed which directly provide binder polymers having a controlled and predetermined size and size distribution suitable for use in electrostatographic toners. One such method is a polymer suspension technique which is known in the prior art as a “limited coalescence” (LC) process, and in particular evaporative limited coalescence process (ELC), as described in U.S. Pat. Nos. 4,833,060, 4,965,131, 6,544,705, 6,682,866, and 6,800,412; incorporated herein by reference for all that they contain.

The preparation of toner polymer powders from a preformed polymer by the chemically prepared toner process such as the evaporative limited coalescence (ELC) process offers many advantages over the conventional grinding method of producing toner particles. In this process, polymer particles having a narrow size distribution are obtained by forming a solution of a polymer in a solvent that is immiscible with water, dispersing, under suitable shear and mixing conditions, the solution so formed in an aqueous medium containing a solid colloidal stabilizer and removing the solvent. Removal of the solvent from the droplets provides solid binder polymer particles that are covered with a layer of smaller stabilizer particles. The resultant polymer particles are then isolated, washed and dried. The size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by mechanical flowing and shearing using rotor-stator type colloid mills, high pressure homogenizers, agitation etc.

The production of near photographic quality images (high gloss, low grain and good resolution) using electrophotographic imaging technology is highly desirable. Toner particle size plays a key role in determining image quality in electrophotographic systems, smaller particles generally yielding better image quality. The preparation of toner polymer powders from a preformed polymer by the chemically prepared toner process such as the “Evaporative Limited Coalescence” (ELC) described above has allowed the formation of toner particles less than 8 microns in diameter and in some instances less than 4 μm.

It is known to increase the gloss of a fused deposit of toner by increasing the amount of lateral spread of the toner under fusing conditions. Lateral flow is affected by binder rheological properties, fuser nip pressure, fusing temperature, and the nature of the fusing surface. However, excessive toner spread during fusing can lead to image detail degradation and paper blistering. In particular, when fusing color images derived from very small toner particles (desired for high resolution), when high photo gloss is desired, ordinary pressure fusing heated rollers operate at high temperatures which in turn causes spreading of the toner on the surface of a receiving sheet, destroying the high resolution created by the fine toner particles. What is desired is a system in which enhanced gloss is observed without excessive increase in the amount of lateral toner spread.

In typical electrostatographic imaging, toner particles are deposited on the surface of the receiving sheet in a series of layers, the height of which is dependent upon the desired density and the particular combination of colors needed to make up the image. This creates a substantial relief in the formed image which is quite noticeable to the eye. This is especially the case with larger and higher mass toner particles. This relief image results in high differential gloss, which may be sufficiently unacceptable that a multicolor print made with it would not be competitive with a comparable silver halide product.

It is also desirable to produce high quality images on substrates that render the print with the look and feel of a typical photographic print produced with silver halide imaging technology, such as the degree and uniformity of glossiness, stiffness and opacity, and high resolution and sharpness with corresponding low grain appearance. The advantages to producing photographic quality images on such substrates using digital electrophotography include improved environmental friendliness, ease of use, and versatility for customizing images, such as when text and images are combined. In addition to 4×6 inch prints, with such glossy images several applications can be envisioned such as photo quality calendars, greeting cards, and postcards among others. To achieve low granularity, low relief, and high uniform gloss, special receivers are known and disclosed in U.S. Pat. Nos. 5,055,371; 5,085,962; 5,089,363; 6,416,874; 6,800,359; 6,818,283; 6,841,227; 7,147,909; 7,211,363; 7,632,562; 7,678,445; 7,754,315 and US Patent Publication No. 2006/0115631. The combination of relatively high pressure and heat to soften the thermoplastic layer during fusing both substantially embeds the toner in the layer, substantially reducing the relief without spreading the image, and also applies a relatively uniform gloss to the image. These receivers are complex and costly, however, requiring the coating or extruding of a thermoplastic toner-image receiving layer onto the base paper.

Additionally, the toner image-receiving layer has high formulation complexity since it must have the features of excellent release and offset resistance during fusing and resistance to cracking. Further, many additives must also be used to achieve, whiteness, writeability, and runnability through the printer. This leads to a high cost receiver limiting the applicability of electrophotographic photoprinting. As a result, there is a need for the production of photoquality images using commercially available inexpensive substrates.

The manufacture and use of porous toner particles to provide the benefit of reduced image relief is described, e.g., in US Publication Nos. US 2008/0176164, US 2008/0176157 and US 2010/0021838.

### PROBLEM TO BE SOLVED BY THE INVENTION

There is a need for a toner and fusing system and method to form glossy photo quality electrophotographic images with the combined benefits of reduced differential gloss, toner spread, and toner relief without the need for special receivers.

### SUMMARY OF THE INVENTION

This invention relates to improving image quality of images. In particular, this invention describes a process of producing an image comprising: transferring porous polymeric marking particles to a receiver; and fixing the marking particles to the receiver by applying heat and pressure by contacting the marking particles with a heated fuser member comprising a topcoat layer having a storage modulus of at least 10 MPa at 175° C. In particular embodiments, the invention is specifically directed towards fusing porous toner materials, and enables reducing the image relief, toner spread, and differential gloss of resulting fused toner images.

The use of porous toners and high storage modulus fuser surfaces provides in the present invention unexpected advantages over solid toners with equivalent rheology. Substantially higher gloss and reduced differential gloss is obtained at similar or reduced toner spread, measured by toner particle area gain, allowing the use of reduced fusing conditions compared to solid toners.

### BRIEF DESCRIPTION OF THE DRAWINGS

FIG. 1 is a cross-sectional view of a fuser member in accordance with an embodiment of the present invention;

FIG. 2 is a schematic cross-sectional view of a fusing apparatus in fusing multicolor images in accordance with an embodiment of the present invention; and

FIG. 3 is a schematic cross-sectional view of the cold compaction press apparatus used to prepare powder samples for subsequent squeeze flow measurement in accordance with examples of the present invention.

For a better understanding of the present invention together with other advantages and capabilities thereof, reference is made to the following description and appended claims in connection with the preceding drawings.

### DETAILED DESCRIPTION OF THE INVENTION

The fusing process employs the application of heat and pressure sufficient to adequately adhere toner to the paper (or other substrate) surface and to achieve an aim toner surface gloss. During the fusing process a nip is formed where the toner is squeezed and undergoes liquefaction, coalescence with other toner particles, spreading, or flow across and into the substrate. As disclosed by Satoh et al. in the Journal of Imaging Science, 35 (6) 1991 pp 373-376, a sufficient degree of flow or toner spread is critical in achieving good adhesion and high gloss at reasonable fusing temperatures and pressures.

A quantitative measurement of lateral spread of a toner particle on fusing as described in this invention is its area gain; calculated as the ratio of the area of a fused toner particle to the projected area of an unfused particle. Area gain is measured at the same fusing conditions used to measure the image surface gloss.

It is known to increase the gloss of a fused deposit of toner by increasing the amount of lateral spread of the dry ink under fusing conditions. The amount of spread can be influenced by binder choice, fusing temperature and dwell time, fuser materials, and other factors. Excessive toner spread during fusing can lead to image degradation.

What is desired is a system in which enhanced gloss is observed without excessive increase in the amount of lateral spread. It has been discovered that the use of porous toner particles in an electrophotographic system which incorporates a high storage modulus fusing surface topcoat provides substantially enhanced gloss over theologically similar solid toners without excessive increase in the amount of lateral spread, measured by area gain. For the purposes of this invention, the term “topcoat” refers to the outer layer of the toner contacting fuser surface.

In accordance with one embodiment, porous toner particles employed in the invention may be made by a multiple emulsion process as described in US 2008/0176164, US 2008/0176157, and US 2010/0021838, the disclosures of which are incorporated by reference herein in their entireties. In one stage of such multiple emulsion process, individual porous particles comprising a continuous polymer phase and internal pores containing an internal aqueous phase are formed, where such individual particles are dispersed in an external aqueous phase. The ELC process is used to control the particle size and distribution. Upon drying, the particles individually comprise a binder polymer and discrete pores in the particle and have a porosity of at least 10% by volume of the particle. A hydrocolloid is preferably employed in the internal aqueous phase to stabilize the discrete pores, such that the resulting particles individually comprise a continuous phase comprising a binder polymer, and a second phase comprising discrete pores in the particle stabilized by the pore stabilizing hydrocolloid. In such specific embodiment, the hydrocolloid may be selected, e.g., from the group consisting of carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate) and polyphosphates, and in a preferred embodiment comprises carboxymethyl cellulose. The size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by mechanical flowing and shearing using rotor-stator type colloid mills, high pressure homogenizers, agitation etc.

As described in such disclosures, porous polymer particles may be prepared from any type of polymer that is soluble in a solvent that is immiscible with water. Useful binder polymers include those derived from vinyl monomers, such as styrene monomers, and condensation monomers such as esters and mixtures thereof. As the binder polymer, known binder resins are useable. These binder resins include, e.g., homopolymers and copolymers such as polyesters, styrenes, e.g. styrene and chlorostyrene; monoolefins, e.g. ethylene, propylene, butylene and isoprene; vinyl esters, e.g. vinyl acetate, vinyl propionate, vinyl benzoate and vinyl butyrate; alpha.-methylene aliphatic monocarboxylic acid esters, e.g. methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers, e.g. vinyl methyl ether, vinyl ethyl ether and vinyl butyl ether; and vinyl ketones, e.g. vinyl methyl ketone, vinyl hexyl ketone and vinyl isopropenyl ketone. Particularly desirable binder polymers/resins include polystyrene resin, polyester resin, styrene/alkyl acrylate copolymers, styrene/alkyl methacrylate copolymers, styrene/acrylonitrile copolymer, styrene/butadiene copolymer, styrene/maleic anhydride copolymer, polyethylene resin and polypropylene resin. They further include polyurethane resin, epoxy resin, silicone resin, polyamide resin, modified rosin, paraffins and waxes. Also, especially useful are polyesters of aromatic or aliphatic dicarboxylic acids with one or more aliphatic diols, such as polyesters of isophthalic or terephthalic or fumaric acid with diols such as ethylene glycol, cyclohexane dimethanol and bisphenol adducts of ethylene or propylene oxides. Typically, the glass transition temperature of the binder polymer is between 40° C. and 80° C., more typically between 45° C. and 70° C. and even more typically, between 50° C. and 65° C.

The porous polymer toner particles employed in the invention may be formulated with carrier particles to make useful developers for electrophotography. U.S. Pat. Nos. 4,546,060 and 4,473,029, the disclosures of which are incorporated herein by reference, e.g., describe that the use of “hard” magnetic materials as carrier particles increases the speed of development dramatically when compared with carrier particles made of “soft” magnetic particles. The preferred ferrite materials disclosed in these patents include barium, strontium and lead ferrites having the formula MO₆Fe₂O₃ wherein M is barium, strontium, or lead. However, magnetic carriers useful in the invention can include soft ferrites, hard ferrites, magnetites, sponge iron, etc. In addition, the magnetic carrier ferrite particles can be coated with a polymer such as mixtures polyvinylidenefluoride and polymethylmethacrylate or silicone resin type materials. Preferably, the toner is present in an amount of about 2 to about 20 percent by weight of the developer and preferably between 5 and 12 weight percent. Preferably, the average particle size ratio of carrier to toner particles is from about 15:1 to about 1:1. However, carrier-to-toner average particle size ratios of as high as about 50:1 can be useful. Preferably, the volume average particle size of the carrier particles can range from about 5 to about 50 microns.

Surface forces of toners are typically modified by application of dry surface treatments to dry toner particles. The terms “surface treatment” or “external additive” are typically used to describe such a toner formulation ingredient that is a dry fine particulate which is added after the core toner particle has been prepared. The most common surface treatments are hydrophobically modified silicas and in particular fumed silicas, but fine particles of titania, alumina, zinc oxide, tin oxide, cerium oxide, and polymer beads can also be used. The fine particles may be chemically modified with silanes or polydimethylsiloxane, e.g., to achieve the desired surface forces and triboelectric function. Varying particle sizes and amounts of surface treatment are used to ensure that the desired separation distance is maintained during violent collisions and shearing motion in toning stations to induce a static charge on the toner, to develop latent images on photoreceptors with toner, to transfer the developed images to intermediate and final receivers, and in other ancillary processes involving toner such as cleaning. Fumed silica is available in a range of primary particle sizes, which is typically measured rather as the specific surface area by the BET nitrogen adsorption method. The surface area equivalent size is size divided by the product of the surface area and the density. The smallest available fumed silica materials have a BET surface area of about 400 m²/g corresponding to silica particle of about 7 nm in size, while the largest available materials have a BET surface area of about 30 m²/g. As a general rule, the smaller the primary particle size of the silica (the higher the BET surface area), the more free-flowing will be the resulting surface treated toner for a given weight percent of silica added.

An organic coating is typically applied to the fumed silica in order to cover surface silanol groups in order to render the silica hydrophobic and control triboelectric charge. Common coatings include silicone fluid also known as polydimethylsiloxane (PDMS), hexamethyldisilazane (HMDZ), and dimethydichlorolsilane (DMDCS) and other alkyl silanes. Such materials are available commercially from vendors including Evonik Degussa Corporation, Cabot Corporation, and Wacker.

The porosity of the toner particles employed in the present invention is at least 5%, preferably greater than 10%, more preferably between 20 and 90% and most preferably between 30 and 70%. For the purpose of this disclosure, the term “conventional toner” means that the particles are essentially nonporous (e.g., porosity less than 5%), irrespective of whether they were made from methods such as compounding and grinding or by chemical means from polymer precursors, such as by emulsion aggregation or limited coalescence, or from preformed polymer, such as is employed by the limited coalescence process and is used to simply differentiate particles that are essentially solid from those that are porous or cavernous.

Toner particles tend to spread during the process of permanently fixing them to the receiver by fusing the particles under heat and pressure. Such spreading decreases the resolution and increases the granularity. With non-porous particles, despite the spreading of the particles, the permanently fixed image still retains a discernible thickness that results in an apparent image relief and differential gloss, especially at the edges where high density regions adjoin low density regions. Such thick images also tend to be brittle and can crack or even flake off when the final receiver member is flexed. These problems are particularly objectionable when the image is rendered glossy, i.e. having a gloss in excess of 10 and particularly in excess of 25 using a G-60 gloss meter.

The rheology of the toner particles is a critical factor in controlling the degree of toner spread. Pores within toner particles act as reinforcing agents that reduce toner melt flow either due to reduced heat transfer by the air in the pores, or due to the foam-like structure of the pores. Therefore, to match the melt flow of a solid toner, a lower viscosity binder must be used in a porous toner. The appropriate binder viscosity can be determined using a squeeze flow experiment on a bulk powder sample formed into a disk, as further described below. Desired toner spread depends on the correct choice of toner rheology. For example, toners with less than desired toner spread (unoptimum rheology) may leave white space in the image even in high toner coverage areas; limiting the maximum attainable image density. In accordance with a preferred embodiment, porous toner particles are employed comprising a binder polymer having melt elastic and loss moduli (G′ and G″) less than 30,000 and 18,000 dyne/cm² respectively at 120° C. and 1 rad/sec frequency. Such rheological behavior of the binder polymer in the molten state can be determined by using a dynamic mechanical rheometer. Toner comprising binder polymer with higher elastic and loss moduli will exhibit lower gloss behavior.

To produce a color image, electrostatic latent images are produced on the primary imaging member corresponding to the specific color information required. While this process can be used with specific spot colors, it is preferable to use this method to produce images corresponding to full color images. In this instance, separations produced typically correspond to cyan, magenta, yellow, and black. Each primary separation is designed so that at maximum density, the substrate is covered with a monolayer of toner particles. The percentage relative to a monolayer is given by the following equation:

$$\% = 100 \times \frac{6 M}{ρ π d ( 1 - φ )}$$

where M is the mass laydown per area, d is the toner diameter, ρ is the weight averaged density of the toner components including any residual silica from the ELC process, and φ is the toner porosity.

Toner particles with 50% porosity should require only half as much binder mass to accomplish the same imaging results. Thus, the use of porous toner particles in the electrophotographic process enables reducing the toner mass and relief in the image area. In dark shades where multiple primary colors come together, the total reduction in relief is substantial. Any decrease in binder polymer usage in the toner must be accompanied by a proportional increase in colorant concentration to maintain density. Image density refers to the reflection density as measured with an X-Rite Densitometer using Status-A filters.

The average particle diameter of the porous particles employed in the present invention is, for example, 2 to 10 microns, preferably 3 to 8 microns, and most preferably 4 to 6 microns. The use of large toner particles results in poorer resolution, increased granularity, and increased throw-off, whereby the toner particles are ejected from the magnetic development station due to the centripetal acceleration resulting from the rotating shell or magnetic core of the magnetic development station. The toner particles that are thrown off are often deposited in background areas of the primary imaging members, thereby resulting in toner particles present in areas that do not correspond to the electrostatic latent image and, thereby, result in a background density, often referred to as background. For the purposes of this invention, unless otherwise specified, the terms “particle size,” “toner size,” “particle diameter,” and “toner diameter” refer to the volume-weighted median diameter, as determined with a device such as a Coulter Multisizer.

Colorants, a pigment or dye, suitable for use in the practice of the present invention are disclosed, for example, in US Reissue Pat. 31,072, and in U.S. Pat. Nos. 4,160,644; 4,416,965; 4,414,152; and 4,229,513. As the colorants, known colorants can be used. The colorants include, for example, carbon black, Aniline Blue, Calcoil Blue, Chrome Yellow, Ultramarine Blue, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 185, C.I. Pigment Yellow 155, C.I. Pigment Yellow 97, C.I. Pigment Yellow 12, CI Pigment Yellow 17, C.I. Pigment Blue 15:1, and C.I. Pigment Blue 15:3. Colorants can generally be employed in the range of from about 1 to about 90 weight percent on a total toner powder weight basis, and preferably in the range of about 2 to about 40 weight percent, more preferably from 4 to 30 weight percent, and most preferably 6 to 20 weight percent in the practice of this invention. When the colorant content is 4% or more and preferably 6% or more by weight, a sufficient coloring power can be obtained, and when it is 30% or less and more preferably 20% or less by weight, good transparency can be obtained. Mixtures of colorants can also be used. Colorants in any form such as dry powder, its aqueous or oil dispersions or wet cake can be used in the present invention. Colorant milled by any methods like media-mill or ball-mill can be used as well. The colorant may be incorporated, e.g., in the oil phase of limited coalescence process, or in the first aqueous phase of a multiple emulsion process as disclosed in US 2010/0021838. In a particular embodiment, the invention employs porous toner particles having a colorant concentration of at least 6% by weight of the particles, and the toner particles have a volume weighted average particle size of less than 8 micrometers.

In a printer a fusing roller is used to apply heat and pressure to an unfused toner image on a receiver sheet such as a clay-coated paper stock. In a particular embodiment, the present invention is particularly advantageous in forming high gloss fused images with controlled differential gloss on relatively high basis weight coated paper receivers of greater than 90 gsm (grams per square meter) basis weight and having 60 degree gloss of greater than 25. Higher basis weight coated paper has higher caliper, greater coating thickness, smoothness, and rigidity to achieve high gloss. Suitable papers are available from a wide variety of companies including, among others, Appleton Papers Inc., Domtar Corp., MeadWestvaco Corp., New Page Corp., Sappi Fine Paper North America, and Smart Papers Holdings LLC. The toner particles are fused together and adhered to the receiver sheet, and become spread out to a certain degree. It is observed that, in general, as the temperature of the fuser roller is increased, the propensity of the toner to offset to the fuser roller increases. However, if a wax release additive is sufficiently released from the toner, the offset will not occur and the image will not be damaged.

Release agents suitable for use as an additive in accordance with the present invention preferably are waxes. Any wax may be used for the purpose of the present invention. Examples of such waxes include polyolefins such as polyethylene wax and polypropylene wax, and long chain hydrocarbon waxes such as paraffin wax. Another class of waxes is carbonyl group-containing waxes which include long-chain aliphatic ester waxes, as well as polyalkanoic acid ester waxes such as montan wax, trimethylolpropane tribehenate, glycerin tribehenate; polyalkanol ester waxes such as tristearyl trimellilate and distearyl maleate; polyalkanoic acid amide waxes such as trimellitic acid tristearyl amide. Examples of useful aliphatic amides and aliphatic acids include oleamide, eucamide, stearamide, behenamide, ethylene bis(oleamide), ethylene bis(stearamide), ethylene bis(behenamide) and long chain acids including stearic, lauric, montanic, behenic, oleic and tall oil acids. Particularly preferred aliphatic amides and acids include stearamide, erucamide, ethylene bis(stearamide) and stearic acid. Mixtures of aliphatic amides and aliphatic acids can also be used. One useful stearamide is commercially available from Witco Corporation as KEMAMIDE S. A useful stearic acid is available from Witco Corporation as HYSTERENE 9718. Naturally occurring polyalkanoic acid ester waxes include Carnauba wax. A particularly useful class of ester waxes is made from long chain fatty acids and alcohol. Examples of this class are LICOWAX series made by Clariant Corp. derived from montanic acid. Another example useful in toner applications is the WE series made by NOF Corporation which is a highly purified narrow melting solid ester wax. Fluorinated waxes such as POLYFLUO 190, POLYFLUO 200, POLYFLUO 523XF, AQUA POLYFLUO 411—all polyethylene/PTFE functionalized waxes, AQUA POLYSILK 19, POLYSIL 14—all polyethylene/PTFE/amide functionalized waxes available from Micro Powders Inc. are also useful. The choice of wax is not limited to a single wax. Two or more of the above waxes may be incorporated into the dispersion to give improved toner performance. The wax WE-3 made by NOF, a long-chain ester wax made from long chain fatty acids and alcohol, is a preferred wax because it has a narrow melting range with little melting that takes place below 40° C. Preferably, the wax employed has a percent crystallinity of greater than 50%.

Although waxes that may be used in the present invention can have a broad range of applications, it is generally desired for toner applications that the wax have a melting point of 40-160° C., preferably 50-120° C., more preferably 60-90° C. A melting point of wax below 40° C. may adversely affect the heat resistance and keep of the toner, while too high a melting point, i.e. in excess of 160° C., is apt to cause cold offset of toner when the fixation is performed at a low temperature. Additionally, it is preferred that the onset of melting to the peak melting temperature be greater than 20° C., preferably greater than 50° C., where the melting peak of wax is obtained by methods such as differential scanning calorimetry. Preferably, the wax has a melt viscosity of 5-1000 cps, more preferably 10-100 cps, at a temperature higher by 20° C. than the melting point thereof. When the viscosity is greater than 1000 cps, the anti-hot offset properties and low fixation properties of the toner are adversely affected. The amount of the wax in the toner is generally 0.1-40% by weight, preferably 0.5-15% by weight, based on the weight of the toner.

Many desired additives are more readily available as aqueous dispersions, and a viable route to incorporating these into chemically prepared toners or other polymer particles is to incorporate them in the first water phase of the multiple emulsion process as described in US 2010/0021838. Many wax and colorant dispersions, especially wax dispersions, e.g., are easier to make in water and more of these are available commercially.

The present invention employs a heated fuser member to fix porous toner marking particles to a receiver. Fuser members as employed in the electrophotographic fixing art in general and the present invention in particular are adapted to apply heat and pressure to a heat-softenable electrostatographic toner on a receiver, such as paper, to permanently fuse the toner to the receiver. Examples of fuser members which may be employed in the present invention include fuser rollers, pressure rollers, fuser plates and fuser belts for use in fuser systems such as fuser roller systems, fuser plate systems, and fuser belt systems. The term “fuser member” is used herein to identify one of the elements of a fusing system. Commonly, the fuser member is a fuser roller or pressure roller and the discussion herein may refer to a fuser roller or pressure roller, however, the invention is not limited to any particular configuration of fuser member.

The heated fuser member employed in the present invention comprises a fuser topcoat layer with a storage modulus of at least 10 MPa at 175° C., and in particular embodiments of from 10 to 60 MPa, and more preferably 20 to 60 MPa at 175° C. When the storage modulus is high a surprising benefit is seen with porous toners where higher gloss is achieved at similar or reduced toner area gain to rheologically similar conventional toners. To enable high gloss in resulting fused toner images, the outer layer surface further preferably has an Arithmetic Average Roughness, Ra, of less than 0.5 micrometers, more preferably less than 0.3 micrometers, and the gloss of the surface finish comprises a G60 of from 14 to 50 and most preferably 25 to 60.

In a preferred embodiment, such relatively high storage modulus topcoat layer comprises a fluoropolymer resin, such as a semicrystalline fluoropolymer or a semicrystalline fluoropolymer composite, and in particular a fluorothermoplastic composition, such as described in U.S. Pat. Nos. 7,494,706; 7,531,237; 7,534,492; and 7,682,542, the disclosures of which are incorporated by reference herein in their entireties. Suitable fluoropolymer materials include polytetrafluoroethylene (PTFE), polyperfluoroalkoxy-tetrafluoroethylene (PFA), polyfluorinated ethylene-propylene (FEP), poly(ethylenetetrafluoroethylene), polyvinylfluoride, polyvinylidene fluoride, poly(ethylene-chlorotrifluoroethylene), polychlorotrifluoroethylene and mixtures of fluoropolymer resins, with PTFE, PFA and FEP preferred materials. Some of these fluoropolymer resins are commercially available from DuPont as TEFLON or SILVERSTONE materials.

The preferred outer layer comprises a polyperfluoroalkoxy-tetrafluoroethylene (PFA), commercially available from DuPont under the trade name TEFLON 855P322-32, TEFLON 855P322-53, TEFLON 855P322-55, TEFLON 855P322-57, TEFLON 855P322-58 and TEFLON 857-210. Particularly TEFLON 855P322-53; TEFLON 855P322-57, and TEFLON 855P322-58 are preferred because they are durable, abrasion resistant and form a very smooth layer. TEFLON 855P322-58 is also known as EM-402CL. The polyperfluoroalkoxy-tetrafluoroethylene (PFA) further comprises filler particles such as silicone carbide, aluminum silicate, carbon black, zinc oxide, tin oxide, etc.

The relatively high storage modulus topcoat outer layer may also comprise compatible first and second fluorothermoplastics, as described in commonly assigned, copending U.S. patent application Ser. No. 12/647,573, “Fuser Member with Fluoropolymer Outer layer,” of Chen, Pickering, and Shih, the disclosure of which is also incorporated by reference herein, wherein the first fluorothermoplastic is a crosslinkable thermoplastic random copolymer and the second fluorothermoplastic is a semicrystalline fluoropolymer or a semicrystalline fluoropolymer composite linear polymer (e.g., PTFE, PFA, FEP), and curing the outer layer to crosslink the first thermoplastic whereby the resulting crosslinked first thermoplastic and the linear polymer form a semi-interpenetrating polymer network (SIPN). In a particular embodiment, a vinylidene fluoride-co-tetrafluoroethylene co-hexafluoropropylene random copolymer, which can be represented as—(VF)(75)-(TFE)(10)-(HFP)(25)-, may be employed as the first fluorothermoplastic. This material is marketed by Hoechst Company under the designation “THV Fluoroplastics” and is referred to herein as “THV.” In another embodiment, a vinylidene fluoride-co-tetrafluoroethylene co-hexafluoropropylene copolymer, which can be represented as—(VF)(42)-(TFE)(10)-(HFP)(58)-, may be used. This material is marketed by Minnesota Mining and Manufacturing, St. Paul, Minn., under the designation “3M THV” and is referred to herein as “THV-200.” Other suitable uncured vinylidene fluoride-cohexafluoropropylenes and vinylidene fluoride-co-tetrafluoroethylene-cohexafluoropropylenes are available, for example, THV-400, THV-500, and THV-300. In general, THV Fluoroplastics are set apart from other melt-processable fluoroplastics by a combination of high flexibility and low process temperature. THV Fluoroplastics are the most flexible of the fluoroplastics. Fuser members formed with a topcoat layer that includes such a SIPN of first and second fluorothermoplastics enables an outer layer which has good performance without requiring high temperature sintering of fluorocarbon resins.

With such a relatively high modulus, the fuser topcoat is relatively non-compliant. An underlying cushion layer may be employed as further described in such referenced patents and publications, along with further described optional subbing, interlayer, tie and priming layers, to make the overall fuser layer compliant and to provide good adhesion between the various layers. The presence of a cushion layer creates a larger contacting zone during which heat and pressure are applied to fuse the toner.

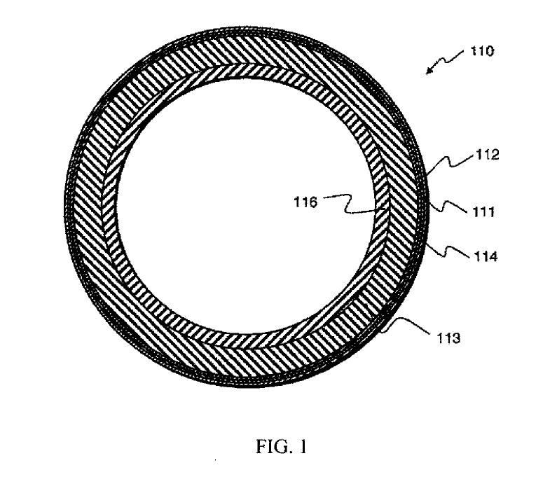

Referring now to the accompanying drawings, FIG. 1 shows a cross-sectional view of a fuser member 110 which may be employed according to an embodiment of the invention, of which the applications include fuser rollers, pressure rollers, and oiled donor rollers, etc. The generally concentric central core or support 116 for supporting the plurality of the layers is usually metallic, such as stainless steel, steel, aluminum, etc. The primary requisite for the central core 116 materials are that it provides the necessary stiffness, being able to support the force placed upon it and to withstand a much higher temperature than the surface of the roller where there is an internal heating source. Deposited above the support 116 is a relatively thick resilient layer, also termed the base cushion layer (BCL) 113, which is characterized in the art as a “cushion” layer, with a function to accommodate the displacement for the fusing nip. Deposited above the base cushion layer 113 is a relatively thin tie layer 114, which can be made of, e.g., VITON, fluoroelastomer, or other fluoropolymer, such as fluorocarbon thermoplastic copolymer and mixtures thereof. Subsequently deposited above the tie layer 114 is a relatively thin primer layer 111. The outermost layer 112, is a toner release layer, which comprises, e.g., a fluoropolymer resin, including fluorothermoplastics PTFE, PFA, and FEP, etc. and blends thereof, deposited on the primer layer 111.

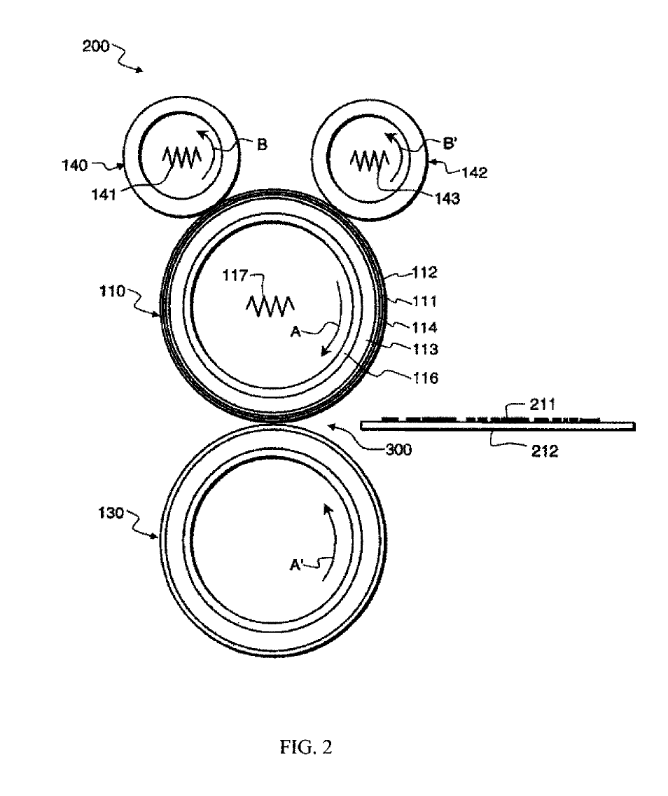

FIG. 2 shows an embodiment of the fuser station, inclusive of the inventive system, as designated by the numeral 200. The rotating fuser member 110 (as described above) moves in the direction indicated by arrow A about the axis of rotation. The surface of the fuser member 110 can be externally heated by heater rollers, 140 and 142, which include incandescent or ohm-rated heating filament 141 and 143, or internally heated by the incandescent or ohm-rated heating filament 117, or heated by the combination of both external heater rollers, 140 and 142, and internally heating incandescent or ohm-rated filament 117. A counteracting pressure roller 130 rotating in the direction A′, countering the fuser roller rotating direction A forms a fusing nip 300 with the fuser roller 110 made of a plurality of layers. An image-receiving substrate 212, typically paper, carrying unfused toner 211, i.e., fine thermoplastic powder of pigments, facing the fuser roller 110 is shown approaching the fusing nip 300. The topcoat outermost layer 112 is a thermally resistant layer used for release of the substrate 212 from the fusing member 110. The substrate is fed by employing well know mechanical transports (not shown) such as a set of rollers or a moving web for example. The fusing station is preferably driven by one roller, for instance the fusing roller 110, with pressure roller 130 and optional heater rollers 140 and 142 being driven rollers.

The fuser member alternatively can be a pressure or fuser plate, pressure or fuser roller, a fuser belt or any other member on which a release coating is desirable. The support for the fuser member can be a metal element with or without additional layers adhered to the metal element. The metal element can take the shape of a cylindrical core, plate or belt. The metal element can be made of, for example, aluminum, stainless steel or nickel. The surface of the metal element can be rough, but it is not necessary for the surface of the metal element to be rough to achieve good adhesion between the metal element and the layer attached to the metal element. The additional support layers adhered to the metal element are layers of materials useful for fuser members, such as silicone rubbers, fluoroelastomers, primers, and topcoats, as described in the above referenced patents and publications.

In cases where it is intended that the fuser member be heated by an internal heater, it is desirable that the outer layer have a relatively high thermal conductivity, so that the heat can be efficiently and quickly transmitted toward the outer surface of the fuser member that will contact the toner to be fused. Depending upon relative thickness, it is generally also very desirable for the base cushion layer and any other intervening layers to have a relatively high thermal conductivity. Internal heating provides less stress and elevated temperature conditions compared to external heating, thus the additional tie layer between the fluorothermoplastic topcoat layer and the compliant silicone substrate may be optional.

The thickness and composition of the base cushion and topcoat release layers can be chosen so that the base cushion layer provides the desired resilience to the fuser member and the topcoat release layer can flex to conform to that resilience. Usually, the release layer is thinner than the base cushion layer. For example, cushion layer thicknesses in the range from about 1.0 mm to about 10.0 mm have been found to be appropriate for various applications. In some embodiments of the present invention the base cushion layer is about 5.0 mm thick and the outer layer is from about 5 μm to about 50 μm thick.

The inclusion of a base cushion layer on the support increases the compliancy of the fuser member. By varying the compliancy, optimum fuser members and fuser systems can be produced. The presently preferred embodiment in a fuser roller system is to have a very compliant fuser roller and a non-compliant or less compliant pressure roller. In a fuser belt system it is preferred to have a compliant pressure roller and a non-compliant or less compliant belt. Although the above are the presently preferred embodiments, fuser systems and members including plates, belts, and rollers can be made in various configurations and embodiments wherein at least one fuser member is made according to this invention.

The topcoat fluoropolymer resin layer may be applied to a fuser member by ring-coating an aqueous emulsion of a fluoropolymer resin. Then, the fuser member may be placed in an oven typically at temperatures between about 600° F. and 700° F. to cure the fluoropolymer resin layer. The surface of the outer layer may then be annealed by contacting the surface of the fuser member to a heating roller at a temperature from 250 to 400° C. to provide a fuser member having a smooth surface finish. The fluoropolymer resin outer layer of the fuser member after annealing has a storage modulus of at least 10 MPa at 175° C., typically of from 10 to 60 MPa, and more preferably 20 to 60 MPa. In addition, the outer layer surface preferably has an Arithmetic Average Roughness, Ra, of less than 0.5 micrometers, more preferably less than 0.3 micrometers, and the gloss of the roller surface finish comprises a G60 of from 14 to 50 and most preferably 25 to 60.

Any kind of known heating method can be used to cure or sinter the layers onto the fuser member, such as convection heating, forced air heating, infrared heating, and dielectric heating.

The fuser members are employed in accordance with the present invention in electrophotographic imaging machines to fuse heat-softenable toner to a substrate. This can be accomplished by contacting a receiver, such as a sheet of paper, to which toner particles are electrostatically attracted in an imagewise fashion with such a fuser member. Such contact is maintained at a temperature and pressure sufficient to fuse the toner to the receiver. Because these members are so durable they can be cleaned using a blade, pad, roller, or brush during use, and although it may not be necessary because of the excellent release properties of the fluoropolymer resin layer, release oils may be applied to the fuser member without any detriment to the fuser member.

The invention will further be illustrated by the following examples. They are not intended to be exhaustive of all possible variations of the invention. While the invention is primarily described, e.g., in connection with electrophotographic toner marking particles, the invention further applies to processes for fixing marking particles applied to a substrate by other than electrophotographic processes, e.g., marking particles applied to a latent image formed by dielectric electrostatography, as well as marking particles applied by inkjet, lithographic, and other printing processes.

### Toner Materials:

The binders used for making toners were bisphenol-A based polyester polymers KAO E and KAO N obtained from Kao Specialties Americas LLC, a part of Kao Corporation, Japan. KAO E elastic and loss moduli were 3,580 and 16,100 dyne/cm² respectively at 120° C. and 1 rad/sec frequency. KAO N at the same conditions had elastic and loss moduli of 20,800 and 36,700 dyne/cm² respectively. Carboxymethyl cellulose molecular weight approximately 250K as the sodium salt, was obtained from Acros Organics. Colloidal silica NALCO 1060 was obtained from Nalco Chemical Company as 50 weight percent dispersions. The wax used in all the examples was the ester wax WE-3.

AEROSIL RY200L2 and RX-50 silicas (PDMS and HMDZ functionalized silicas respectively having BET surface areas of 200 and 50 m²/g) were both obtained from Evonik Degussa Corporation. STX-501 titania (HMDZ functionalized, BET surface area of 30 m²/g) was also obtained from Evonik Degussa Corporation.

### Conventional Solid (Nonporous) Toner Preparation

An oil phase was prepared by dissolving 9.18 kg of KAO N polyester and 1.67 kg of a cyan PB 15:3 colorant masterbatch from Sun Chemicals (40% pigment and 60% binder) in 48.03 kg of ethyl acetate. 3.84 kg of a WE-3 wax dispersion (25% wax and 5% dispersant) in ethyl acetate was then added to the oil phase. The resultant oil phase was added to 114.86 kg of a pH 4.7 buffered (100 mM acetate buffer) aqueous phase containing 5.93 kg of NALCO1060. This mixture was then subjected to shear using a Silverson Model L4R mixer, followed by homogenization at very high shear in a multiple orifice homogenizer operating at 5000 psi. The resultant oil-in-water dispersion was diluted with demineralized water containing aluminum nitrate (shape control agent) at 0.056 wt % of the oil phase. The total dilution level of the dispersion was 1:1.2 and the ethyl acetate removed in a continuous evaporator under reduced pressure at 55′C. The colloidal silica on the surface of the resultant toner particles was removed by raising the pH of the slurry to 12.6 for 15 minutes. These particles were filtered, washed with water, and dried. The concentration of wax and pigment in the toner were 8.0 and 5.6 wt % respectively. Median particle size of the toner was 5.6 microns measured by Coulter Counter.

The level of surface treatment relative to dry toner for the conventional solid toner was 0.9, 0.6, 4.0% (RY200L2, STX-501, RX-50, respectively). The surface treatment processing step was done in a 10 L Henschel mixer. The toner and surface treatment additives were mixed for 30 minutes at 3000 RPM.

### Porous Toner Preparation

A 2 wt % CMC (MW 250K) was prepared by dissolving 0.21 kg in 10.56 kg of demineralized water. An oil phase was prepared by first dissolving 5.40 kg of KAO E polyester and 0.11 kg of a charge control agent, FCA-2508N, from Fujikura Kasie Co., Ltd in 21.78 kg of ethyl acetate. 3.78 kg of an ethyl acetate based cyan PB 15:3 colorant dispersion (14.8% pigment and 5.2% dispersants) and 3.90 kg of an ethyl acetate based WE-3 wax dispersion (14.4% wax solids and 3.6% dispersant) were then added to the oil phase. The CMC solution was then dispersed in the final oil phase using a Silverson L4R homogenizer. The resultant water-in-oil emulsion was further homogenized using a multiple orifice homogenizer at 5000 psi. This very fine water-in-oil emulsion was added to 81.71 kg of a second water phase comprising a 200 mM pH 4 citric acid phosphate buffer and 3.43 kg of NALCO 1060, followed by homogenization in a multiple orifice homogenizer at 2000 psi to form a water-in-oil-in-water double emulsion. The resultant double emulsion was diluted with demineralized water containing poly (2-ethyl-2-oxazoline) at 0.047 wt % of the oil phase. The total dilution level of the dispersion was 1:0.8. The ethyl acetate was removed in a continuous evaporator under reduced pressure at 55° C. The silica was removed by raising the pH of the slurry to 12.6 for 15 minutes. These particles were filtered, washed with water, and dried. The concentration of wax and pigment in the toner were each 8.0 wt %. Median particle size of the porous toner was 5.9 measured by Coulter Counter.

The level of surface treatment relative to dry toner for the porous toner was 1.15, 0.35, 5.6% (RY200L2, STX-501, RX-50, respectively). The surface treatment processing step was done in a 10 L Henschel mixer. The toner and surface treatment additives were mixed for 10 minutes at 3000 RPM.

### Porosity Measurement

The level of porosity of the particles of the present invention was measured using a combination of methods. To accurately determine the extent of porosity in the particles of the present invention a combination of conventional diameter sizing and time-of-flight methods was used. Conventional sizing methods include total volume displacement methods such as Coulter particle sizers or image based methods such as the Sysmex FPIA3000 system. The time-of-flight method used to determine the extent of porosity of the particles in the present invention includes the Aerosizer particle measuring system. The Aerosizer measures particle sizes by their time-of-flight in a controlled environment. This time-of-flight depends critically on the density of the material. If the material measured with the Aerosizer has a lower density due to porosity or a higher density due, for example, to the presence of fillers, then the calculated diameter distribution will be shifted artificially low or high respectively. Independent measurements of the true particle size distribution via alternate methods (e.g. Coulter or Sysmex) can then be used to fit the Aerosizer data with particle density as the adjustable parameter. The method of determining the extent of particle porosity of the particles of the present invention is as follows. The outside diameter particle size distribution is first measured using either the Coulter or Sysmex particle measurement systems. The mode of the volume diameter distribution is chosen as the value to match with the Aerosizer volume distribution. The same particle distribution is measured with the Aerosizer and the apparent density of the particles is adjusted until the mode (D50%) of the two distributions matches. The ratio of the calculated and solid particle densities is taken to be the extent of porosity of the particles (1—Aeorsizer density/density of solid particle). The calculated porosity values generally have uncertainties of +/−10%. The porosity of the porous toner prepared as described above was 42%.

### Squeeze Flow Measurement

Rheological characterization of the toners was done using squeeze flow. The experiment is performed at constant temperature and compression plate speed. The squeeze flow is discussed in “Rheological measurement,” 2nd ed., Chapman and Hall, New York, 1993. True (natural or Hencky) stress—strain curves were obtained over typical toner temperature fusing conditions and these data were also converted to an effective viscosity versus strain rate curves.

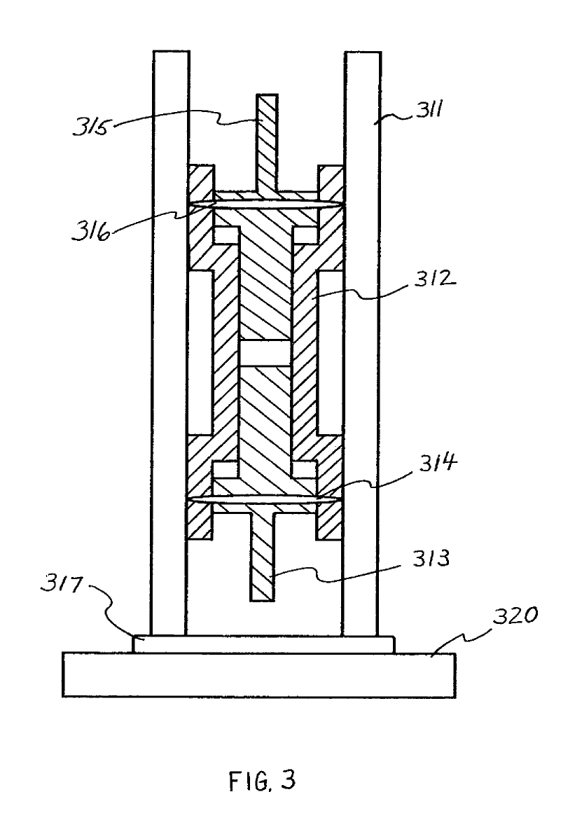

Standard oscillatory shear or capillary viscometry characterization techniques could not be used on porous toners since the sample preparation and long temperature equilibration steps results in almost complete loss of the porosity. To accurately measure the rheology a more rapid sample preparation technique (see FIG. 3 and description below) and rheological measurement (squeeze flow) technique that better mimics the deformation in the fusing nip were implemented. Squeeze flow is a bulk measurement of compressed and/or melted toner at constant temperature and compression speed. It captures the essential features of fusing process. In these experiments the measured force is converted to a stress (constant plate area) and the engineering strain is converted to a Hencky (or True) strain. The data are plotted as stress—strain curves. The strain (change in plate separation) correlates with lateral spread (material ejected from between the plates). For a given stress level, the strain correlates well with the single toner particle area gain fusing experiments of the present invention.

To retain the porosity of individual toner particles in a packed toner sample prior to squeeze flow measurements, a drop tube apparatus was developed and is shown in FIG. 3. The basic idea is that of a “drop-tube,” commonly used to pack powders in tubes. The drop tube apparatus of FIG. 3 includes an outer pipe 311, an inner casing 312, a bottom piston 313, a bottom pin 314, a top piston 315, a top pin 316, and a foam pad 317 placed on a supporting structure 320. Utilizing the two pistons approach shown in FIG. 3 halved the pressure gradient at impact across the thickness of the disk. To further adjust the energy dissipated during the impact a foam pad, or cushion, 317 was used as a landing pad. The thickness of the foam rubber pad was 1 inch, but this was not critical. The drop height was varied. Optimization of the drop height with and without the foam cushion led to a powder packing procedure that made a disk of toner between top piston 315 and bottom piston 313 with a minimized porous particle porosity loss that had enough integrity to be removed from the cold compaction press and inserted into a RSA-II (see instrument details below) for squeeze flow measurements.

Lower pin 314 holds the bottom piston 313 in place in the casing 312 during powder loading and drop step to facilitate sample loading, removal, and cleaning. The top pin 316 was inserted in the top piston 315 for handling ease, and removed prior to the drop step. A very thin channel (not shown) is cut along inside of the casing to allow air to escape around the pistons. The outer pipe 311 used to guide the drop is 1 mm wider than the inner casing 312. Drop height is controlled by varying the pipe length. A long neck funnel, or “drop tube,” is used to pour the powder onto the lower piston 313 in the channel where the top piston will move at impact.

The packed powder disks were then pretreated at 100° C. for 5 minutes then removed from the melt oven and the sample height measured with a micrometer. This enabled an effective determination of the initial sample height (necessary for knowing the strain rate), which was quite difficult without the heat treatment as the disk would crumble in the micrometer. With this process, 2 mm high, 8 mm outside diameter disks were prepared. The particles underwent a 10% decrease in porosity as a result of sample preparation as described here. For example, a starting porosity of 42% was reduced to approximately 32% after the powder was packed into a disc and pretreated at 100° C. for 5 minutes.

Squeeze flow measurements were done using an RSA-11 from TA Instruments of New Castle, Del. Drop tube pellet samples made of toners were placed in between the RSA-II 6 mm outside diameter parallel plates. For each set temperature, the height reduction and load applied to the toner disk was recorded. The Hencky strain is defined as ln[h(t)/h(0)] where h(t) is the plate separation at time t. This strain measure corresponds to a summation of incremental strains applied over time, which is exactly what occurs in the squeeze flow experiment. A smaller plate allowed more force build up before the maximum load on the transducer was exceeded. Also, the 6 mm plates were knife edged and tapered inward from the sample edge to reduce the propensity of molten polymer to stick to the edge as it is extruded from the plates. Appealing to the definition of viscosity as a resistance to flow, an effective viscosity is the stress divided by deformation rate. The deformation rate in a constant plate impingement velocity squeeze flow experiment increases as the sample height decreases since it is defined to be the plate velocity divided by the sample height at each instant in time.

TABLE 1

| | | | | Rheology | | | | | | | |
|---|---|---|---|---|---|---|---|---|---|---|---|
| Conventional | | | | matched porous | | | | More elastic | | | |
| (Solid) Toner | | | | toner | | | | porous toner | | | |
| | Temp [° C.] | | | | Temp [° C.] | | | | Temp [° C.] | | |
| stress | 90 | 100 | 110 | stress | 90 | 100 | 110 | stress | 90 | 100 | 110 |
| MPa | Hencky strain | | | MPa | Hencky strain | | | MPa | Hencky strain | | |
| 0.10 | 0.09 | 0.37 | 0.61 | 0.10 | 0.10 | 0.30 | 0.69 | 0.10 | 0.08 | 0.21 | 0.43 |
| 0.30 | 0.31 | 0.75 | 0.96 | 0.30 | 0.36 | 0.72 | 1.17 | 0.30 | 0.27 | 0.51 | 0.82 |
| | Temp [° C.] | | | | Temp [° C.] | | | | Temp [° C.] | | |
| Strain | 90 | 100 | 110 | Strain | 90 | 100 | 110 | Strain | 90 | 100 | 110 |
| Rate | Viscosity | | | Rate | Viscosity | | | Rate | Viscosity | | |
| 1/s | kPa · s | | | 1/s | kPa · s | | | 1/s | kPa · s | | |
| 0.38 | 985 | 241 | 106 | 0.38 | 733 | 241 | 112 | 0.38 | 1010 | 499 | 154 |

Table 1 shows a summary of the toner properties. One can see that the conventional toner with Binder KAO N is theologically similar to the porous toner with Binder KAO E. When Binder KAO N is used with either toner, the toners are considerably more viscous and show less strain.

### Area Gain Measurement

A quantitative measurement of lateral spread of a toner particle on fusing is its area gain; calculated as the ratio of the area of a fused toner particle to the projected area of an unfused particle. To calculate the area gain, the cumulative distribution of sizes for both fused and unfused particles (100-200 toner particles each) were plotted. The resulting cumulative fused areas at 10%, 25%, 50%, 75%, and 90% were then plotted versus the corresponding unfused cumulative area values at the same frequency points. The resulting data was then fit with a linear regression line and the slope of the regression line taken as the average area gain for the toner under the specified fusing conditions. To generate toner “images” containing single particles, a MECCA device was used. The apparatus consists of two parallel metal plates separated by insulating posts about 1 cm high. An AC electromagnet is located beneath the lower plate to provide magnetic agitation, while a DC electric potential of about 2500 volts can be applied across the plates. A sample of about 0.1 gram of developer is weighed and placed on the lower plate. Next, both the electric and magnetic fields are applied for 40 seconds. The toner is separated from the carrier by the combined agitation and electric field and is transported to the upper plate by the electric field. Between the upper and lower plates is the paper substrate. The MECCA device creates a toner profile where the density of toner particles decreases from the center to the outer edge. Towards the periphery of the toner deposit large numbers of single particles are present. Image analysis of the unfused particles showed that the weight averaged median size was equivalent to the Coulter Counter particle size results. A commercially-available pen tablet interfaced to the image analysis software was used to identify the edges of the particles and calculate the area in square microns.

The toners were evaluated in three different fuser configurations (Fusers A, B, and C described below) employing different topcoat compositions. All three fuser members were internally heated.

### Topcoat Storage Modulus: Dynamic Mechanical Analyzer

The topcoat samples were tested on an RSA II Dynamic Mechanical Analyzer (DMA) and required a sample geometry of 7.5 mm×23 mm with a thickness between 30 microns to 2000 microns. Free standing films were tested at a frequency of 1 Hz and a strain of 0.07%. The test was recorded over a temperature scan of 100° C. to 200° C. Over the temperature scan an oscillatory strain is applied to the sample and the resulting stress is measured. These values are related to materials properties by E′ and E″ (storage and loss moduli). As a result of DMA testing, the storage modulus (E′) of the topcoat material is determined at a typical fusing temperature of 175° C.

### Topcoat Surface Roughness Measurements

Fuser rollers prepared as described below were subject to roughness measurements using a Federal Surfanalyzer 4000 Profilometer provided with a 10 μm radius parallel chisel sapphire stylus moving at a speed of 2.5 mm/sec. Surface roughness is reported as Ra, or Arithmetic Average Roughness.

### Fuser A

A core consisting of a cylindrical aluminum tube having a length of 15.2 inches and an outer diameter of 6.4 inches was cleaned with dichloromethane and dried. The outer surface of the core was then primed with a uniform coat of a silicone primer, i.e., GE 4044 silicone primer available from GE Silicones of Waterford, N.Y. The core was then air dried.

A resilient silicone base cushion layer EC-4952 was then applied to the so-treated core. EC-4952 is obtainable from Emerson Cuming Silicones Division of W.R.Grace and Co. of Lexington, Mass. The EC-4952 base compound is believed to contain a hydroxy-terminated poly(dimethylsiloxane) polymer with about 33% by weight, based on the weight of the EC-4952 base compound, of aluminum oxide and iron oxide therein as thermally conductive fillers. The EC 4952 base compound includes a cross-linking agent which is added by the manufacturer. An effective amount (about 1 part catalyst to 300 parts base compound) of dibutyltin diacetate catalyst is added to the mill to initiate curing of the material according to the manufacturer's directions.

The above-described silicone mixture is then degassed and blade coated onto the core according to conventional methods. The so-coated core is maintained at room temperature, i.e. a temperature of 25° C., for about 24 hours. The core is then placed in a convection oven wherein the temperature therein is ramped to 210° C. over a period of 12 hours, followed by a 48 hour hold at 210° C. to substantially complete curing of the silicone mixture. The so-coated core is then allowed to cool to room temperature, and the poly(dimethylsiloxane) base cushion layer is thereafter ground to provide a layer having a thickness of about 1 mm (40 mils). The base cushion is then subjected to corona discharge treatment at a power level of 750 watts for 15 minutes.

The primer layer TEFLON 855N-702 available from DuPont Co., comprising perfluoroalkoxy resin and trifluoroethylene-perfluoroethylvinyl etherperfluoroethylene vinyl phosphate, was ring coated onto a core ground resilient layer as previously described, then air dried 1 hours. The conditions for the post-cure were a 1 hour ramp to 120° C. and 2 hours at 120° C. The resulting PFA primer TEFLON 855N-702 layer had 2 to 5 micron in thickness. An outer layer of Dupont TEFLON EM-402CL, a PFA fluoropolymer resin was ring-coated onto the primer layer and was 12.5 μm in thickness. The fuser member was then placed in a convection oven at 700° F. for approximately 10 minutes to sinter the PFA prior to being annealed.

The fuser roller coated with PFA fluoropolymer after being baked at a temperature above its melting temperature and cooled down to room temperature is next engaged with a set of annealing hard rollers of 2″ in diameter, preferably chromed with the surface temperature of the heated rollers above the melting point, such as 310° C., set the fuser member to roll against the heater rollers at 3 rpm, and use 30 seconds to gradually increase the contact pressure from 0 to 50 psi. As the full engagement starts, allow the fuser roller to roll through the nip between itself and the annealing roller for 3 minutes until a desired, usually smoothed surface gradually emerges. The roller was gradually cooled down and the heater roller disengaged. A gloss measurement was taken for the coated roller after curing and cooling to room temperature. The G-60 gloss is determined by using Gardener Micro-TRI-Gloss 20-60-85 Glossmeter, available from BYK Gardener River Park, Md. The G-60 gloss of the fuser topcoat was 45. Average surface roughness, Ra, was 0.13 microns. The storage modulus of the outer topcoat layer was 35 MPa at 175° C.

### Fuser B

The fuser roller for configuration B was an original equipment manufactured fuser roller from a Xerox Phaser 7500 network color printer. The G-60 gloss of the fuser roller surface was 27. Average surface roughness, Ra, was 0.25 microns. The fuser roller consisted of a 35 μm fluorothermoplastic sleeve molded onto a resilient base cushion. The storage modulus of the outer fluorothermoplastic layer was 27 MPa at 175° C.

### Fuser C

Similar to Fuser A, a core consisting of a cylindrical aluminum tube having a length of 16.2 inches and an outer diameter of 3.0 inches was coated and cured with a resilient layer of EC 4952. The poly(dimethylsiloxane) base cushion layer is thereafter ground to provide a layer having a thickness of about 1 mm (40 mils). The base cushion is then subjected to corona discharge treatment at a power level of 750 watts for 15 minutes.

A fluorosilicone interpenetrating network (IPN) coating solution was prepared at 25 weight percent solids in methyl ethyl ketone (MEK). Firstly, VITON A, a ter-polymer of vinylidene fluoride, hexafluoropropylene and tetrafluoroethylene fluoropolymer from DuPont was dissolved in MEK at 22 weight percent solids overnight. Secondly, CURATIVE 20 and CURATIVE 30, both available from Momton Chemical Co., were then added and allowed to dissolve. Thirdly, Magnesium Oxide MAGLITE D and Y, both from Merck and Co., were added to the solution and milled for 40 minutes at 400 rpm using a 750 cc model HD01 attritor from Union Process, Akron Ohio. Lastly, SFR-100 available from General Electric Co. was added and the solution rolled overnight. The final coating solution contained 100 pph VITON A, 3 pph MAGLITE D, 12 pph MAGLITE Y, 2.5 pph CURATIVE 20, 6 pph CURATIVE 30, and 20 pph SFR-100.

The resulting coating solution was ring coated onto the core with the resilient layer in two passes, air dried and cured by ramping to 260° C. over 8 hours, and maintaining 260° C. for 24 hours. The dry thickness of the coating on the roller was 25 gm. The G-60 gloss of the fuser topcoat was 12. Average surface roughness, Ra, was 0.53 microns. The storage modulus of the outer topcoat layer was 2 MPa at 175° C.

The rheologically similar toners were evaluated in three fuser apparatuses. Electrostatographic developers were prepared using a strontium ferrite carrier coated with a mixture of polyvinylidene fluoride and poly(methyl methacrylate) resins. Images comprising patches of varying density were prepared on an electrophotographic printing device and transferred to a 118 gram per square meter (gsm) STERLING ULTRA DIGITAL coated paper stock obtained from NewPage Corporation of Miamisburg, Ohio. The printer parameters including the charging voltage, the magnetic brush bias voltage, and the toner concentration in the developer, were adjusted to achieve the desired toner laydown measured in mg/cm². The final toner patches were made up of 1×10 cm toner laydown patches on 1.5×4″ STERLING ULTRA DIGITAL paper. Fuser A was evaluated in a NexPress 53000 Digital Printing Press where the oiler had been disengaged. The fusing speed was 17.2 inches per second. Since the NexPress required full sheets to the fuser, the leading edge of the patches were taped onto a larger 118 gsm basis weight STERLING ULTRA DIGITAL paper. These 236 gsm combined basis weight test sheets were then fused using Fuser A. Fuser B was evaluated in an off-line Xerox PHASER 7500 oil-less fuser running at 3.2 inches per second using the small patches of toner on the 118 gsm paper. Fuser C was evaluated in an off-line EKTAPRINT 250 oiled fuser running at 6.4 inches per second using small patches. This EKTAPRINT fluorosilicone roller required amine functional PDMS release oil. The oil had an amine equivalency of 0.012 meq/gm and a 350 centistokes viscosity at 25° C.

Table 2 summarizes the fuser temperatures, nips, and load stress used and the resulting gloss and area gain data. The use of porous toners and high storage modulus Fuser A and Fuser B topcoat surfaces provide in the present invention unexpected advantages over solid toners with equivalent rheology. Substantially higher gloss is obtained at similar or reduced toner spread, for the porous toner measured by toner particle area gain, allowing the use of reduced fusing conditions compared to solid toners. This effect is not seen with low modulus Fuser C topcoat surface even at high stress load.

TABLE 2

| | | Toner | | | | | | | |
|---|---|---|---|---|---|---|---|---|---|
| | | Contacting | Fuser/ | | | | | Single | |
| | | Layer | Pressure | | | | G-60 | Particle | |
| | | Modulus | Roller | Fuser | | | Image | Area | |
| | | at 175° C. | Nip | Temp | Stress | | Gloss | Gain | |
| | Fuser | (MPa) | (mm) | (° C.) | (MPa) | Toner | (X) | (Y) | (X/Y) |
| Example 1 | Fuser A | 35 | 15.2 | 185 | 0.29 | Porous | 60 | 3.3 | 18 |
| Comparative | | | | | | Conventional | 34 | 3.9 | 9 |
| Example 1 | | | | | | | | | |
| Example 2 | Fuser A | 35 | 17.3 | 200 | 0.37 | Porous | 74 | 4.3 | 17 |
| Comparative | | | | | | Conventional | 41 | 4.8 | 9 |
| Example 2 | | | | | | | | | |
| Example 3 | Fuser B | 27 | 6.2 | 185 | 0.11 | Porous | 38 | 2.9 | 13 |
| Comparative | | | | | | Conventional | 26 | 2.9 | 9 |
| Example 3 | | | | | | | | | |
| Comparative | Fuser C | 2 | 5.2 | 185 | 0.73 | Porous | 24 | 2.3 | 10 |
| Example 4 | | | | | | | | | |
| Comparative | | | | | | Conventional | 24 | 2.2 | 11 |
| Example 5 | | | | | | | | | |

The above data further demonstrates the advantage of the present invention in accordance with specific embodiments employing a fusing member topcoat layer having an average surface roughness Ra of less than 0.5 microns in obtaining fused monolayer images having G60 gloss value X of greater than 10 (preferably at least 25 and more preferably at least 35) and fused individual marking particles having an average single particle area gain Y of less than 5, wherein the ratio X/Y is greater than 11 (and preferably greater than or equal to 13), thereby enabling relatively high gloss at relatively low single particle area gain.

Differential gloss over 20 to 100% laydown and toner relief at 200% laydown were measured using variable tint images. Unfused images were printed onto 8.5×11 inch STERLING ULTRA DIGITAL 118 and 216 gsm paper using a NexPress 53000 and fused as full sheets off-line in the Xerox PHASER 7500 Fuser. The fusing speed was 3.1, inches per second and the fusing temperature was 200° C. Table 3 summarizes the relief, average gloss, and gloss range. The use of porous toners and high storage modulus fuser B surface provides in the present invention unexpected advantages over conventional solid toners with equivalent rheology. Substantially higher gloss, reduced differential gloss and relief is obtained with porous toner compared to conventional solid toners.

TABLE 3

| | | Toner | | | G-60 | |
|---|---|---|---|---|---|---|
| | | Contacting | | | Average | G-60 Gloss |
| | | Layer | | Relief | Gloss | Range |
| | | Modulus | | 200% | (100 and | (Max-Min of |
| | | at 175° C. | | images | 200% | 20-100% |
| | Fuser | (MPa) | Toner | (um) | images) | images) |
| Example 4 | Fuser B | 35 | Porous | 53 | 31 | 7 |
| Comparative | | | Conventional | 7.5 | 25 | 12 |
| Example 6 | | | | | | |

The invention has been described in detail with particular reference to certain preferred embodiments thereof, but it will be understood that variations and modifications can be effected within the scope of the invention.

What is claimed is:

1. A process of producing an image comprising:
transferring porous polymeric marking particles to a receiver; and
fixing the marking particles to the receiver by applying heat and pressure by contacting the marking particles with a heated fuser member comprising a topcoat layer having a storage modulus of at least 10 MPa at 175″ C.

2. The process according to claim 1, wherein the marking particles have a colorant concentration of at least 6% by weight of the marking particles.

3. The process according to claim 2, wherein the marking particles have a volume weighted average particle size less than 8 micrometers.

4. The process according to claim 1, wherein the fuser member topcoat layer comprises a thermoplastic layer.

5. The process according to claim 1, wherein the fuser member topcoat layer has an average surface roughness Ra of less than 0.5 microns and the marking particles are fused under conditions such that a resulting monolayer image has G60 gloss value X of greater than 10 and fused individual marking particles have an average single particle area gain Y of less than 5, and X/Y is greater than 11.

6. The process according to claim 5, wherein the marking particles are fused such that a resulting monolayer image has a G60 gloss value of at least 25.

7. The process according to claim 5, wherein the marking particles are fused such that a resulting monolayer image has a G60 gloss value of at least 35.

8. The process according to claim 5, wherein the marking particles are fused such that X/Y is greater than or equal to 13.

9. The process according to claim 1 wherein the fuser member comprises a smooth heated web or roller having an average surface roughness Ra of less than 0.5 microns, wherein the web or roller is heated to a temperature above the glass transition temperature of the polymer of the marking particles in a vicinity where the marking particle bearing receiver is pressed against the heated roller or web.

10. The process according to claim 1, wherein the marking particles individually comprise a binder polymer and discrete pores in the particle and have a porosity of at least 10% by volume of the particle.

11. The process according to claim 10, wherein the marking particles further comprise pigment and wax.

12. The process according to claim 10, wherein the binder polymer has a melt elastic and loss moduli (G′ and G″) less than 30,000 and 18,000 dyne/cm² respectively at 120° C. and 1 rad/sec frequency.

13. The process according to claim 10 wherein the binder polymer comprises a polyester.

14. The process according to claim 10, wherein the marking particles individually comprise:
a continuous phase comprising a binder polymer; and
a second phase comprising discrete pores in the particle stabilized by a pore stabilizing hydrocolloid.

15. The process according to claim 14, wherein the hydrocolloid is selected from the group consisting of carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate), and polyphosphates.

16. The process according to claim 14 wherein the hydrocolloid is carboxymethyl cellulose.

17. The process according to claim 10 wherein the porosity is from 30 to 70 percent.

18. The process according to claim 1, wherein the fuser member topcoat layer comprises a fluoropolymer layer.

19. The process according to claim 1, wherein the fuser member comprises:
a core member comprising a rigid outer surface; and
an outer topcoat layer comprising fluoropolymer resin selected from the group consisting of polytetrafluoroethylene, polyperfluoroalkoxy-tetrafluoroethylene, polyfluorinated ethylene-propylene, and blends thereof.

20. The process according to claim 19 wherein the fuser member further comprises a resilient layer comprising an elastomer disposed between the core member and the topcoat layer.

21. The process according to claim 20, wherein the resilient layer has a thickness of from 1 to 10 mm, and the topcoat layer has a thickness of from 5 to 50 micrometers.

22. The process according to claim 1, wherein the topcoat layer comprises polyperfluoroalkoxy-tetrafluoroethylene.

23. The process according to claim 1, wherein the receiver comprises a coated paper receiver having a basis weight of greater than 90 gsm and a G-60 gloss value greater than 25.

24. An article comprising a receiver and a fused image obtained according to the process of claim 1, wherein the receiver is a coated paper receiver, and resulting monolayer portions of the fused image have a G60 gloss value X of greater than 10 and fused individual marking particles of the fused image have an average single particle area gain Y of less than 5, and X/Y is greater than 11.
